(19) United States
(12) Patent Application Publication
(10) Pub. No.: US 2012/0236298 A1
(43) Pub. Date: Sep. 20, 2012

(54) TUNABLE APPARATUS FOR PERFORMING SERS

(76) Inventors: Michael Josef Stuke, Palo Alto, CA (US); Zhiyong Li, Redwood City, CA (US); Wei Wu, Palo Alto, CA (US); Shih-Yuan Wang, Palo Alto, CA (US); Min Hu, Sunnyvale, CA (US); Fung Suong Ou, Palo Alto, CA (US)

(21) Appl. No.: 13/048,594

(22) Filed: Mar. 15, 2011

(51) Int. Cl. G01J 3/44

(52) U.S. Cl. 356/301

(57) ABSTRACT

A tunable apparatus for performing Surface Enhanced Raman Spectroscopy (SERS) includes a deformable substrate and a plurality of SERS-active nanoparticles disposed at a plurality of locations on the deformable substrate. The plurality of SERS-active nanoparticles are to enhance Raman scattered light emission from an analyte molecule located in close proximity to the SERS-active nanoparticles. In addition, the deformable substrate is to be deformed to vary distances between the SERS-active nanoparticles, in which varying distances between the SERS-active nanoparticles varies enhancement of an intensity of Raman scattered light emission from the analyte molecule.

### CROSS REFERENCE TO RELATED APPLICATIONS

The present application contains common subject matter with copending and commonly assigned U.S. patent application Ser. No. 12/771,779, filed on Apr. 30, 2010, and U.S. patent application Ser. No. 13/029,915, filed on Feb. 17, 2011, the disclosures of which are hereby incorporated by reference in their entireties.

### BACKGROUND

Detection and identification or at least classification of unknown substances has long been of great interest and has taken on even greater significance in recent years. Among advanced methodologies that hold a promise for precision detection and identification are various forms of spectroscopy, especially those that employ Raman scattering. Spectroscopy may be used to analyze, characterize and even identify a substance or material using one or both of an absorption spectrum and an emission spectrum that results when the material is illuminated by a form of electromagnetic radiation (for instance, visible light). The absorption and emission spectra produced by illuminating the material determine a spectral ‘fingerprint’ of the material. In general, the spectral fingerprint is characteristic of the particular material or its constituent elements facilitating identification of the material. Among the most powerful of optical emission spectroscopy techniques are those based on Raman scattering.

Raman scattering optical spectroscopy employs an emission spectrum or spectral components thereof produced by inelastic scattering of photons by an internal structure of the material being illuminated. These spectral components contained in a response signal (for instance, a Raman signal) may facilitate determination of the material characteristics of an analyte species including identification of the analyte.

Unfortunately, the signal produced by Raman scattering is extremely weak in many instances compared to elastic or Rayleigh scattering from an analyte species. The Raman signal level or strength may be significantly enhanced by using a Raman-active material (for instance, Raman-active surface), however. For instance, the Raman scattered light generated by a compound (or ion) adsorbed on or within a few nanometers of a structured metal surface can be 10³-10¹² times greater than the Raman scattered light generated by the same compound in solution or in the gas phase. This process of analyzing a compound is called surface-enhanced Raman spectroscopy (“SERS”). In recent years, SERS has emerged as a routine and powerful tool for investigating molecular structures and characterizing interfacial and thin-film systems, and even enables single-molecule detection. Engineers, physicists, and chemists continue to seek improvements in systems and methods for performing SERS.

### BRIEF DESCRIPTION OF THE DRAWINGS

Features of the present disclosure are illustrated by way of example and not limited in the following figure(s), in which like numerals indicate like elements, in which:

FIG. 1A shows an isometric view of a tunable SERS-active apparatus, according to an example of the present disclosure;

FIG. 1B shows a simplified example of a deformable substrate depicted in FIG. 1A in a pre-deformed or original state, according to an example of the present disclosure;

FIGS. 1C and 1D, respectively, depict simplified examples of the deformable substrate depicted in FIG. 1B in respective deformed states, according to examples of the present disclosure;

FIGS. 1E and 1F, respectively, depict isometric views of a tunable SERS apparatus, according to examples of the present disclosure;

FIGS. 2A and 2B, respectively, show block diagrams of SERS systems employing any of the apparatuses depicted in FIGS. 1A-1F, according to examples of the present disclosure;

FIG. 3 shows a flow diagram of a method for performing SERS to detect an analyte molecule using a SERS system depicted in FIGS. 2A and 2B, according to an example of the present disclosure; and

FIG. 4 shows a schematic representation of a computing device to implement or execute the method depicted in FIG. 3, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Disclosed herein are an apparatus and method for performing surface enhanced Raman spectroscopy (SERS) to detect a molecule in an analyte sample with a relatively high level of sensitivity. The apparatus includes a deformable substrate and SERS-active nanoparticles disposed on the deformable substrate. As the substrate is deformed, the relative distances between the SERS-active nanoparticles varies, which also varies enhancement of an intensity of Raman scattered light emission from the analyte molecule. Thus, the level of Raman scattered light emission enhancement may substantially be tuned by deforming the substrate into multiple deformation states. In one regard, the level of Raman scattered light emission enhancement may be tuned to generate the highest level of Raman scattered light emission and therefore the largest signal from which analysis on the analyte molecule may be performed.

Throughout the present disclosure, the terms “a” and “an” are intended to denote at least one of a particular element. As used herein, the term “includes” means includes but not limited to, the term “including” means including but not limited to. The term “based on” means based at least in part on. In addition, the term “light” refers to electromagnetic radiation with wavelengths in the visible and non-visible portions of the electromagnetic spectrum, including infrared and ultra-violet portions of the electromagnetic spectrum.

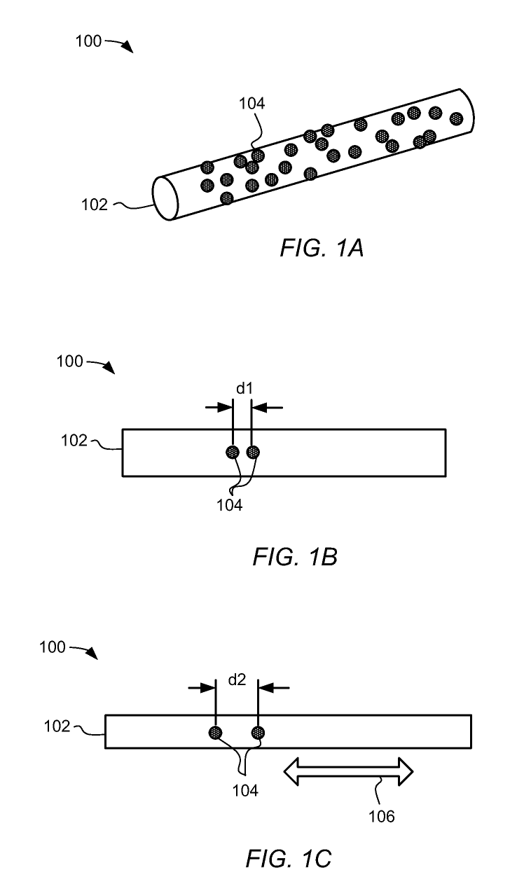

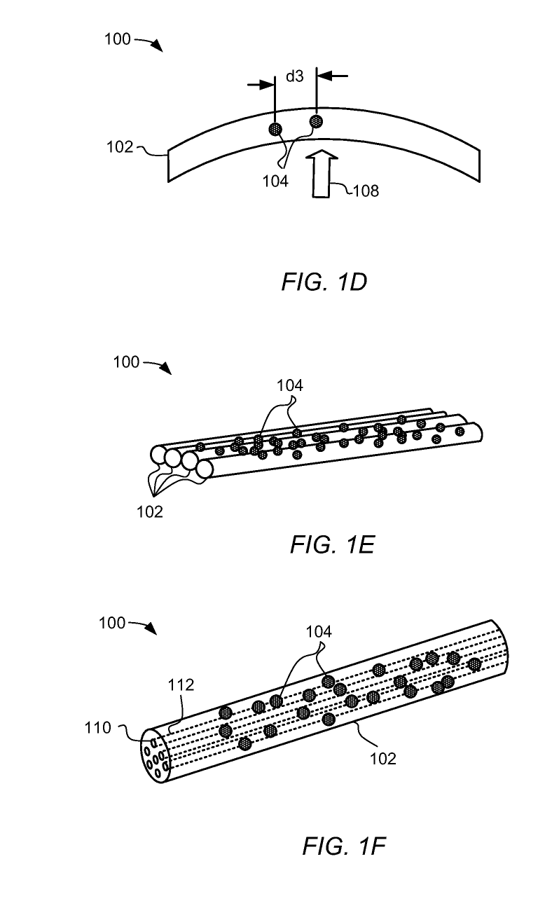

FIG. 1A shows an isometric view of a tunable SERS-active apparatus 100, according to an example. It should be understood that the apparatus 100 depicted in FIG. 1A may include additional components and that some of the components described herein may be removed and/or modified without departing from a scope of the apparatus 100. It should also be understood that the components depicted in FIG. 1A are not drawn to scale and thus, the components may have different relative sizes with respect to each other than as shown therein.

The apparatus 100 is operable to facilitate performance of SERS in detecting an analyte molecule with a relatively high level of sensitivity. More particularly, the apparatus 100 is operable to be tuned to vary the enhancement of the intensity of Raman scattered light emission from an analyte molecule located near or on the apparatus 100. The apparatus 100 includes a deformable substrate 102 and a plurality of SERS-active nanoparticles 104 disposed at a plurality of locations along the deformable substrate 102. The substrate 102 may be formed of any suitable material that is at least one of plastically, elastically, and resiliently deformable. In this regard, the deformable substrate 102 may be bent, stretched, and/or compressed to a range of deformation levels without substantially breaking or otherwise coming apart.

According to a particular example, the deformable substrate 102 comprises a rubber or other deformable material. By way of particular example, the deformable substrate 102 comprises a fiber formed of silk extruded by a spider. In this example, the deformable substrate 102 comprises proteinaceous spider silk extruded from a spider's spinnerets. The spider silk is a suitable deformable material for the substrate 102 because the spider silk is known to be reversibly stretchable by about 20% or more.

Although the SERS-active nanoparticles 104 have been depicted as being disposed over particular sections of the deformable substrate 102, the SERS-active nanoparticles 104 may be disposed substantially over the entire surface of the deformable substrate 102. By way of particular example, the SERS-active nanoparticles 104 may be disposed on a top section of the deformable substrate 102 as a substantially continuous layer, while the remaining sections of the deformable substrate 102 are substantially uncovered. In any regard, the SERS-active nanoparticles 104 may be disposed onto the deformable substrate 102 through any suitable deposition techniques, such as, physical vapor deposition (PVD), chemical vapor deposition (CVD), sputtering, etc., of metallic material, or self-assembly of pre-synthesized nanoparticles. In addition, the SERS-active nanoparticles 104 may be composed of silver (“Ag”), gold (“Au”), copper (“Cu”), platinum (“Pt”), and/or another metal suitable for forming a structured metal surface that when illuminated by excitation light, enhances the intensity of the Raman scattered light emission from an analyte molecule located near or on the apparatus 100. By definition herein, a SERS-active material is a material that facilitates Raman scattering and the production or emission of the Raman signal from an analyte adsorbed on or in a surface layer or the material during Raman spectroscopy.

Although the deformable substrate 102 has been depicted as having a cylindrical shape, the deformable substrate 102 may have various other shapes without departing from a scope of the apparatus 100. For instance, the deformable substrate 102 may have a substantially rectangular or other multi-sided cross-sectional shape. As another example, the deformable substrate 102 may have an amorphous-shaped cross-section. In addition, or alternatively, the deformable substrate 102 may have a relatively roughened surface and/or depressions to substantially increase the surface area over which the SERS-active nanoparticles 104 may be disposed. The roughness and/or depressions may be formed into the surface of the deformable substrate 102 through a suitable modification process, such as, indenting, drilling, etching, etc. In addition, or alternatively, the roughness and/or depressions may naturally be formed into the deformable substrate 102 as may occur, for instance, with various types of proteinaceous spider silk.

The deformable substrate 102 may have a width that ranges from, for instance, about 100 nm to about 10 microns, and a length that ranges from, for instance, about 1 micron to about a couple of meters. In addition, the SERS-active nanoparticles 104 may have sizes that range from, for instance, about 1 nm to about 100 nm.

According to an example, the deformable substrate 102 comprises an optical waveguide through which excitation light may be propagated. In this example, the deformable substrate 102 comprises a substantially transparent structure. By way of particular example, the deformable substrate 102 comprises a material that emits between about 70% to about 100% of the excitation light to be emitted therethrough.

Turning now to FIGS. 1B-1D, there are shown side views of the apparatus 100 depicted in FIG. 1A, according to various examples. It should also be understood that the components depicted in FIG. 1A are not drawn to scale and thus, the components depicted therein may have different relative sizes with respect to each other than as shown therein. In addition, the amount of deformation of the deformable substrate 102 depicted in FIGS. 1C and 1D are for purposes of illustration and should not be construed as limiting the apparatus 100 to what is depicted therein. Moreover, although FIGS. 1C and 1D depict the deformable substrate 102 as being expanded (FIG. 1C) and bent (FIG. 10), it should be understood that the deformable substrate 102 may be deformed in other manners, such as, by being compressed in at least one dimension, being twisted along at least one dimension, or combinations of various deformations.

The apparatuses 100 have been depicted in FIGS. 1B-1D with two SERS-active nanoparticles 104 to simplify a description of the features depicted in those figures. It should, however, be clearly understood that a larger number of nanoparticles 104 may be disposed on the deformable substrate 102 without departing from a scope of the apparatuses 100 depicted in FIGS. 1B-1D. For instance, substantially the entire surface of the apparatuses 100 may be covered with SERS-active nanoparticles 104. In addition, each of the SERS-active nanoparticles 104 depicted in FIGS. 1A-1D may represent groups of SERS-active nanoparticles 104.

FIG. 1B depicts a simplified example of the deformable substrate 102 in a pre-deformed or original state and FIGS. 1C and 1D depict examples of the deformable substrate 102 in respective deformed states. FIGS. 1C and 1D depict the apparatus 100 during application of a mechanical force, which are represented by the arrows 106 and 108. The mechanical force may be applied, for instance, by a mechanical stage or other suitable actuator with around micrometer or larger resolution. More particularly, FIG. 1C depicts an example in which the deformable substrate 102 is stretched or elongated as denoted by the arrow 106 and FIG. 1D depicts an example in which the deformable substrate 102 is bent as denoted by the arrow 108.

As shown in FIG. 1B, a pair of SERS-active nanoparticles 104 are spaced apart from each other by an original distance “d1”. Following stretching of the deformable substrate 102 as shown in FIG. 1C, the nanoparticles 104 are spaced apart from each other by a distance “d2”, which is greater than the original distance “d1”. Likewise, following bending of the deformable substrate 102 as shown in FIG. 1D, the nanoparticles 104 are spaced apart from each other by a distance “d3”, which differs from the original distance “d1”. The distance between the nanoparticles 104 may thus be varied by varying the deformation of the substrate 102. The distance between the nanoparticles 104 may also be varied along other axes when the substrate 102 is deformed as shown in FIG. 1D and/or when the substrate 102 is deformed in other respects, such as, by twisting of the substrate 102. According to a particular example, the nanoparticles 104 are disposed as a substantially continuous layer on the deformable substrate 102 and the deformations depicted in FIGS. 1C and 1D cause gaps to occur along various locations throughout the layer of nanoparticles 104. As the deformable substrate 102 is further deformed, the gaps between the nanoparticles 104 may continually be increased. In examples where the deformable substrate 102 comprises a resilient material, the substrate 102 may substantially return to its original state, which may the nanoparticles 104 along the breaks or rifts to come back together, when the deforming force is removed.

By varying the distances between the SERS-active nanoparticles 104 or groups of SERS-active nanoparticles 104, the enhancement of the intensity of Raman scattered light emission from an analyte molecule may be varied. According to an example, and as discussed in greater detail herein below, the deformation of the substrate 102 may be modified to tune the intensity of the Raman scattered light emitted from the analyte molecule.

Turning now to FIG. 1E, there is shown an isometric view of a tunable SERS apparatus 100, according to another example. It should be understood that the apparatus 100 depicted in FIG. 1E may include additional components and that some of the components described herein may be removed and/or modified without departing from a scope of the apparatus 100. It should also be understood that the components depicted in FIG. 1E are not drawn to scale and thus, the components may have different relative sizes with respect to each other than as shown therein.

As shown in FIG. 1E, the apparatus 100 is depicted as having a plurality of deformable substrates 102, in which, the SERS-active nanoparticles 104 are disposed on the deformable substrates 102. Each of the deformable substrates 102 may be configured in any of the manners as discussed above with respect to FIGS. 1A-1D. In addition, although the deformable substrates 102 have been depicted as being arranged substantially along a common plane, the deformable substrates 102 may be arranged in various other configurations. For instance, the deformable substrates 102 may be arranged in a three-dimensional bundle or array. In addition, or alternatively, the deformable substrates 102 may be in a stacked arrangement in which the deformable substrates 102 are aligned substantially parallel with respect to each other or in which the deformable substrates 102 cross each other and thus do not extend in substantially parallel relationship with respect to each other. In any of the examples above, the deformable substrates 102 may be separated from each other or attached together through use of adhesives, heat bonding, etc.

Although not explicitly depicted in FIG. 1E, the deformable substrates 102 may be deformed in any of the manners discussed above with respect to FIGS. 1A-1D to vary the distances between at least some of the nanoparticles 104. In one example, the deformable substrates 102 are deformed together as a group. In another example, less than all of the deformable substrates 102 are deformed. In this example, various ones of the deformable substrates 102 may be deformed at a given time to further tune the intensity of the Raman scattered light emitted from an analyte molecule.

Turning now to FIG. 1F, there is shown an isometric view of a tunable SERS apparatus 100, according to another example. It should be understood that the apparatus 100 depicted in FIG. 1F may include additional elements and that some of the elements described herein may be removed and/or modified without departing from a scope of the apparatus 100. It should also be understood that the elements depicted in FIG. 1F are not drawn to scale and thus, the elements may have different relative sizes with respect to each other than as shown therein.

As shown in FIG. 1F, the deformable substrate 102 is depicted as having a plurality of holes 110 that extend at least a portion of the length of the apparatus 100, as denoted by the dashed lines 112. In one regard, the apparatus 100 comprises a holey fiber. The holes 110 may be positioned in a symmetric or asymmetric pattern and the deformable substrate 102 may include any number of holes 110, from one hole 110 up to a maximum number that may be formed in the deformable substrate 102 based upon the diameters of the holes 110 and the width of the substrate 102. The diameters of the holes 110 may depend upon the diameter or width of the deformable substrate 102 as well as the desired functionalities of the holes 110.

According to an example, the apparatus 100 depicted in FIG. 1F may be implemented as an optical waveguide through which light waves may be propagated through the apparatus 100, and more particularly, through the holes 110. The holes 110 may be empty or a material (not shown) may be provided in the holes 110. The material may comprise a material that substantially enhances SERS performance or provides another function in the apparatus 100. In this regard, for instance, the material may comprise a transparent material, a reflective material, a material comprising reflective particles, etc. In addition, the material may substantially fill the holes 110, partially fill the holes 110, line the holes 110, etc. In addition, or alternatively, the material may comprise a material that enhances resiliency of the deformable substrate 102.

Although not explicitly depicted in FIG. 1F, the deformable substrate 102 may be deformed in any of the manners discussed above with respect to FIGS. 1A-1D to vary the distances between at least some of the nanoparticles 104. In addition, the holes 110 may be formed to extend a distance other than the entire length of the apparatus 110 and may be formed through implementation of any suitable fabrication technique, such as, drawing of a relatively larger form of the deformable substrate 102 having the holes 110 to a smaller form, drilling the holes 110, etching the deformable substrate 102 to form the holes 110, etc. Moreover, although the holes 110 have been depicted as having circular cross sections, the holes 110 may have any other suitable cross sections, such as, triangular, rectangular, hexagonal, etc. In addition, or alternatively, the holes 110 may naturally be formed into the deformable substrate 102 as may occur with various types of proteinaceous spider silk.

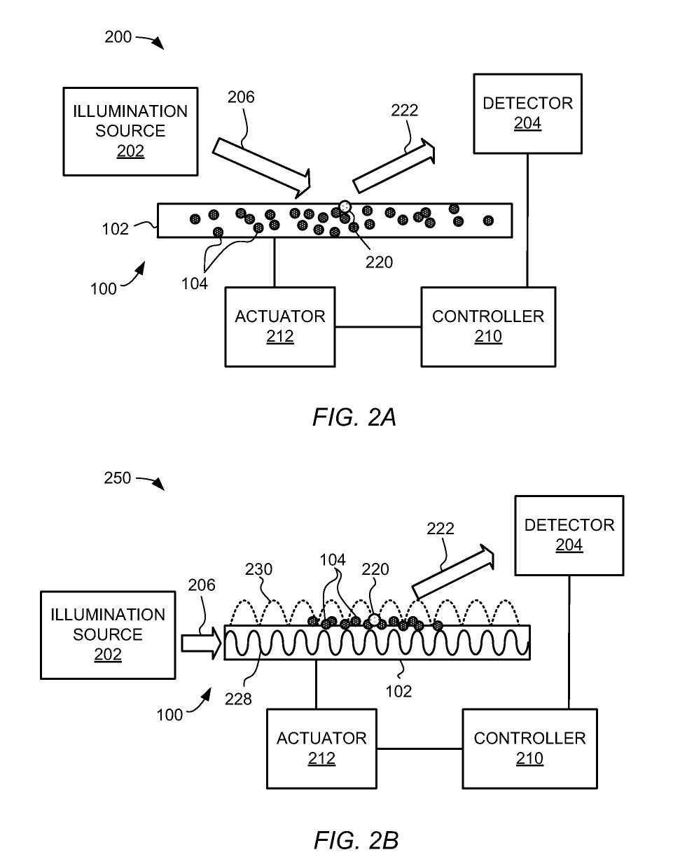

With reference now to FIGS. 2A and 2B, there are shown respective block diagrams of surface enhanced Raman spectroscopy (SERS) systems 200 and 250 employing any of the apparatuses 100 depicted in FIGS. 1A-1F, according to two examples. It should be understood that the systems 200 and 250 respectively depicted in FIGS. 2A and 2B may include additional components and that some of the components described herein may be removed and/or modified without departing from scopes of the systems 200 and 250. It should also be understood that the components depicted in FIGS. 2A and 2B are not drawn to scale and thus, the components may have different relative sizes with respect to each other than as shown therein.

The SERS systems 200 and 250 are both depicted as including a deformable substrate 102 having SERS-active nanoparticles 104 disposed thereon, an illumination source 202, a detector 204, a controller 210, and an actuator 212. In addition, an analyte molecule 220 upon which SERS is to be performed is also depicted as being positioned on the deformable substrate 102 adjacent to some of the SERS-active nanoparticles 104. Although not shown, the SERS systems 200 and 250 may also include an analyte source from which the analyte molecule 220 may be introduced into the SERS systems 200 and 250. Alternatively, however, the analyte molecule 220 may be supplied from an external analyte source or contained in an ambient environment of the SERS systems 200 and 250.

With reference first to FIG. 2A, the illumination source 202 is depicted as emitting electromagnetic radiation, as represented by the arrow 206, which may comprise, for instance, excitation light, onto the analyte molecule 220. By way of example, the illumination source 202 comprises a laser source that supplies the apparatus 100 with visible light. The excitation light 206 illuminates the SERS-active nanoparticles 104 and the analyte molecule 220, which generally enhances the emission of Raman scattered light from the analyte molecule 220. More particularly, the illumination of the SERS-active nanoparticles 104 causes hot spots of relatively large electric field strength to be generated. The excitation light 206 also causes analyte molecules 220 contained in the hot spots to emit detectable Raman light similar to other types of illumination, such as, laser light. The intensities of these hot spots may vary depending upon the relative positions of the SERS-active nanoparticles 104. In addition, the intensities of the electric fields generated at the hot spots generally affect the enhancement of the rate at which Raman light is scattered by an analyte molecule 220 positioned at or near the hot spots.

The Raman scattered light emitted from the analyte molecule 220, which is represented by the arrow 222, is shifted in frequency by an amount that is characteristic of particular vibrational modes of the analyte molecule 220. The detector 204 is to collect the Raman scattered light 222 and spectral analysis may be performed on the Raman scattered light 222 to identify the analyte molecule 220. The intensity of the Raman scattered light 222 may be affected by the relative positions of the SERS-active nanoparticles 104 with respect to each other and the analyte molecule 220. As such, and according to an example, the deformable substrate 102 may be deformed in any of the manners discussed above to vary the relative positions of at least some of the SERS-active nanoparticles 104 with respect to each other and the analyte molecule 220 to, for instance, tune the intensity of the Raman scattered light emitted from the analyte molecule 220. In this regard, the deformable substrate 102 may be deformed into a plurality of deformation states or levels until a maximum Raman scattered light intensity is determined.

As shown in FIG. 2A, the deformable substrate 102 may be deformed by an actuator 212, such as, a mechanical stage, a microelectromechanical system, etc., which may deform the substrate 102 in any of the manners discussed above with respect to FIGS. 1C and 1D. Thus, for instance, one end of the deformable substrate 102 may be fixedly attached to a structure and the other end of the substrate 102 may be attached to the actuator 212. In this example, the actuator 212 may apply a force on the substrate 102 to elongate, compress, twist, bend, etc., the substrate 102. In examples in which the substrate 102 is formed of a resiliently deformable material, the substrate 102 substantially returns to an original condition following removal of the force applied by the actuator 212. According to an example, the actuator 212 is to deform the substrate 102 with a resolution down to the sub-nanometer range and up to the micrometer range.

Although the actuator 212 may be manually controlled by an operator, the actuator 212 may be controlled by a controller 210. The controller 210 may comprise machine-readable instructions stored on a memory or a hardware component, such as, a computer, a processor, an application-specific integrated circuit, etc. In any regard the controller 210 may control the actuator 212 to iteratively apply different levels of force on the substrate 102 over a SERS operation period. According to an example, the controller 210 may receive information pertaining to the Raman scattered light emissions that the detector 204 detects at the different substrate 102 deformations and may cause the actuator 212 to vary the application of force applied on the substrate 102 based upon the received information. Thus, for instance, if the controller 210 determines that the intensity of the Raman scattered light 222 is increasing as the substrate 102 is being compressed during consecutive iterations, the controller 210 may control the actuator 212 to further compress the substrate 102. Otherwise, if the controller 210 determines that the intensity of the Raman scattered light 222 is decreasing as the substrate 102 is being compressed during consecutive iterations, the controller 210 may control the actuator 212 to reduce the compression of the substrate 102 and may being expansion of the substrate 102.

Although the Raman scattered light 222 has been depicted as being directed toward the detector 204, the Raman scattered light 222 is emitted in multiple directions. In this regard, some of the Raman scattered light 222 may be directed into the substrate 102. More particularly, for instance, in examples where the substrate 102 comprises an optical waveguide, Raman-scattered light 222 may be generated in the substrate 102 as a result of the analyte molecule 220 coupling to the evanescent field of a waveguide mode. In these instances, the detector 204 may be positioned to detect the waves generated in the substrate 102 from the Raman-scattered light 222. For instance, the detector 204 may be coupled to the substrate 102 through an optical fiber (not shown) to collect the waves generated by the Raman-scattered light 222 in the substrate 102. In any regard, the detector 204 may include a filter to filter out light originating from the illumination source 202, for instance, through use of a grating-based monochrometer or interference filters.

In addition, the Raman-scattered light 222 may be collected into a single optical mode for each substrate 102 when a plurality of substrates 102 are employed, which generally allows for more efficient spectroscopy. In addition, the Raman-scattered light 222 from the substrate 102 may be imaged onto a narrow slit. By contrast, in SERS systems that use conventional free-space optics, light collected from a large area cannot be imaged onto a narrow slit, and the device either requires a substantially large optical system or provides low throughput.

The detector 204 generally converts the Raman-scattered light 222 emitted from the analyte molecule(s) 220 into electrical signals that may be processed to identify, for instance, the analyte molecule 220 type. In some examples, the detector 204 is to output the electrical signals to other components (not shown) that process the electrical signals. In other examples, the detector 204 is equipped with processing capabilities to identify the analyte molecule 220 type.

Turning now to FIG. 2B, the SERS system 250 includes each of the elements depicted in the SERS system 200 of FIG. 2A, except that the deformable substrate 102 comprises an optical waveguide. More particularly, instead of directly applying the excitation light 206 onto the SERS-active nanoparticles 104 and the analyte molecule 220, the illumination source 202 is depicted as directing the excitation light 206 into the deformable substrate 102. According to an example, the illumination source 202 is directly coupled to the substrate 102 through an optical fiber (not shown) and the excitation light 206 is pumped directly into the substrate 102 through the optical fiber.

As shown in FIG. 2B, the electromagnetic radiation (or excitation light) 206 propagates through the substrate 102 as a wave 228. As the wave 228 propagates through the substrate 102, evanescent waves 230 are generated outside of the substrate 102. More particularly, for instance, the evanescent waves 230 are generated by the wave 228 because the wave 228 strikes the interior walls of the substrate 102 at angles greater than the so-called critical angle. The area outside of the substrate 102 in which the evanescent waves 230 are emitted is defined herein as the evanescent field. According to an example, the electromagnetic radiation 206 is polarized prior to being emitted into the substrate 102 to enhance evanescent wave 230 generation toward the analyte molecule 220 and the SERS-active nanoparticles 104.

Generally speaking, the evanescent waves 230 illuminate the SERS-active nanoparticles 104, thereby causing hot spots of relatively large electric field strength. The evanescent waves 230 also cause analyte molecules 220 contained in the hot spots to emit detectable Raman light similar to other types of illumination, such as, laser light. The intensities of these hot spots may vary depending upon the relative positions of the SERS-active nanoparticles 104. In addition, the intensities of the electric fields generated at the hot spots generally affect the enhancement of the rate at which Raman light is scattered by an analyte molecule 220 positioned at or near the hot spots. As discussed above with respect to FIG. 2A, the substrate 102 may be deformed into various deformation states to tune the Raman scattered light emission from the analyte molecule 220.

According to an example, each of the SERS systems 200 and 250 depicted in FIGS. 2A and 2B comprises a system that is integrated on a single chip. For example, the output of the substrate 102 may be connected to an arrayed waveguide grating (AWG filter). The substrate 102 may also be directly coupled to optical fibers in the SERS systems 200, 250 through which the illumination light 206 may be supplied and, in certain instances, through which the Raman scattered light 222 may be outputted. In this example, the SERS systems 200, 250 provide relatively more compact solutions than coupling free-space signals to fibers. Additionally, the SERS systems 200, 250 may be implemented efficiently for a relatively large sensing area for which the free-space signals are substantially more complex and/or expensive to implement. The substrates 102 in the SERS systems 200, 250 may also be directly coupled to optical fibers in particular instances to form compact field sensors. In these instances, the illumination source 202, for instance an excitation laser, and the detector 204, for instance, spectral analysis equipment, may be housed in a remote location.

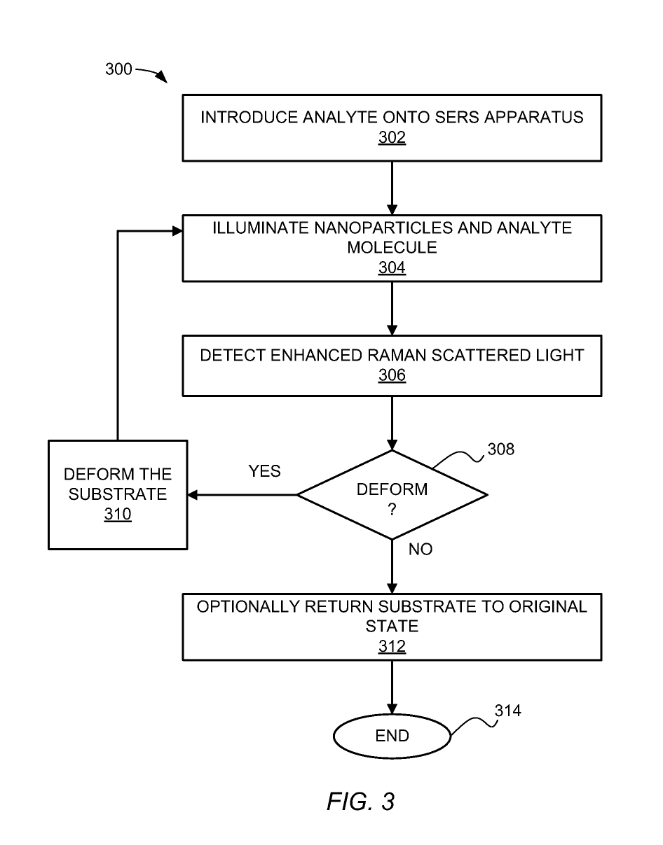

Turning now to FIG. 3, there is shown a flow diagram of a method 300 for performing surface enhanced Raman spectroscopy (SERS) to detect an analyte molecule 220 using a SERS system 200, 250, according to an example. In this regard, the controller 210 depicted in FIGS. 2A and 2B may implement some or all of the operations contained in the method 300. It should be understood that the method 300 depicted in FIG. 3 may include additional processes and that some of the processes described herein may be removed and/or modified without departing from a scope of the method 300. In addition, although particular reference is made herein to the SERS systems 200, 250 in implementing the method 300, it should be understood that the method 300 may be implemented through use of a differently configured SERS system without departing from a scope of the method 300.

At block 302, an analyte containing an analyte molecule 220 to be detected is introduced onto the apparatus 100. The analyte may be introduced intentionally from an analyte source or from analyte contained in a surrounding environment of the SERS system 200, 250. In addition, introduction of the analyte may cause an analyte molecule 220 to become positioned on or near SERS-active nanoparticles 104, for instance, as depicted in FIG. 2A.

At block 304, the SERS-active nanoparticles 104 and the analyte molecule 220 are illuminated to cause Raman scattered light to be emitted from the analyte molecule 220. As discussed above with respect to the SERS system 200 in FIG. 2A, the SERS-active nanoparticles 104 and the analyte molecule 220 may be directly illuminated by the excitation light 206 emitted from an illumination source 202. Alternatively, as discussed above with respect to the SERS system 250 in FIG. 2B, in which the substrate 102 comprises an optical waveguide, the SERS-active nanoparticles 104 and the analyte molecule 220 may be illuminated by evanescent waves 230 generated from the excitation light 206.

At block 306, the detector 204 detects the Raman scattered light 222, if any, produced from the analyte molecule 220. The Raman scattered light 222 may be detected using free space optics or through emission of the Raman scattered light through the substrate 102 as discussed above with respect to FIGS. 2A and 2B. As discussed above, the detected Raman scattered light 222 may be processed in various manners to identify the analyte molecule 220.

At block 308, a determination as to whether the deformable substrate 102 is to be deformed may be made. Block 308 may be omitted or may automatically be defaulted to the “yes” condition during a first iteration of the method 300 to therefore cause the substrate 102 to be deformed at least once during implementation of the method 300.

At block 310, in response to a determination that the substrate 102 is to be deformed at block 308, the substrate 102 may be deformed. More particularly, for instance, the actuator 212 may be instructed to apply a deforming force onto the substrate 102 in any of the manners as discussed above with respect to FIGS. 2A and 2B. In addition, as noted at block 304, the excitation light 206, and/or the evanescent waves 230, may continue to or be re-activated to illuminate the SERS-active nanoparticles 104 and the analyte molecule 220 to cause the analyte molecule 220 to emit Raman scattered light 222 with the substrate 102 in the deformed condition and the Raman scattered light 222 may be detected at block 306. Moreover, at block 308, a determination as to whether the substrate 102 is to be deformed may again be made. The determination to deform the substrate 102 at block 308 may be based upon one or more factors. For instance, the substrate 102 may be deformed for a predetermined number of iterations of blocks 304-310, until a maximum intensity of Raman scattered light emission has been found, until expiration of a predetermined amount of time, etc. Accordingly, blocks 304-310 may be repeated for a number of iterations until a determination at block 308 that no further deformations are to be made.

Following the “no” condition at block 308, the deformable substrate 102 may optionally be returned to its original state, as indicated at block 312. In other words, the actuator 212 may be controlled to apply an opposite deforming force on the substrate 102 to return the substrate 102 back to its original state. In examples in which the substrate 102 is formed of a resiliently deformable material, the deforming force may be removed from the substrate 102 and the substrate 102 may return to the state that the substrate 102 had prior to being deformed due to the resiliency of the substrate 102. Otherwise, the deformable substrate 102 may be caused to remain in the deformed state. In any regard, the method 300 may end as indicated at block 314 following block 312.

Some or all of the operations set forth in the method 300 may be contained as a utility, program, or subprogram, in any desired computer readable storage medium. In addition, the operations may be embodied by computer programs, which may exist in a variety of forms both active and inactive. For example, they may exist as machine readable instruction(s) comprised of program instructions in source code, object code, executable code or other formats. Any of the above may be embodied on a computer readable storage medium, which include storage devices.

Examples of computer readable storage media include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

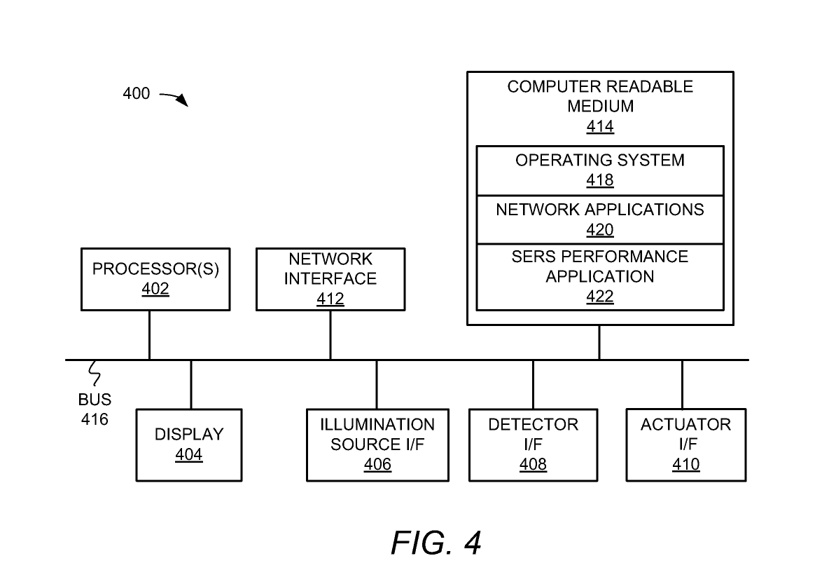

Turning now to FIG. 4, there is shown a schematic representation of a computing device 400 to implement or execute the method 300, according to an example. The computing device 400 includes a processor 402, such as a central processing unit; a display device 404, such as a monitor; an illumination source interface 406; a detector interface 408; an actuator interface 410; a network interface 412, such as a Local Area Network LAN, a wireless 802.11x LAN, a 3G mobile WAN or a WiMax WAN; and a computer-readable medium 414. Each of these components is operatively coupled to a bus 416. For example, the bus 416 may be an EISA, a PCI, a USB, a FireWire, a NuBus, or a PDS.

The computer readable medium 414 may be any suitable non-transitory medium that participates in providing instructions to the processor 402 for execution. For example, the computer readable medium 414 may be non-volatile media, such as an optical or a magnetic disk; volatile media, such as memory; and transmission media, such as coaxial cables, copper wire, and fiber optics.

The computer-readable medium 410 may also store an operating system 418, such as Mac OS, MS Windows, Unix, or Linux; network applications 420; and SERS performance application 422. The operating system 418 may be multi-user, multiprocessing, multitasking, multithreading, real-time and the like. The operating system 418 may also perform basic tasks such as recognizing input from input devices, such as a keyboard or a keypad; sending output to the display 404; keeping track of files and directories on the computer readable medium 410; controlling peripheral devices, such as disk drives, printers, image capture device; and managing traffic on the bus 416. The network applications 420 include various components for establishing and maintaining network connections, such as machine readable instructions for implementing communication protocols including TCP/IP, HTTP, Ethernet, USB, and FireWire.

The SERS performance application 422 provides various software components for implementing a SERS apparatus 100 to detect analyte molecules 220, as described above. In certain examples, some or all of the processes performed by the SERS performance application 422 may be integrated into the operating system 418. In certain examples, the processes may be at least partially implemented in digital electronic circuitry, or in computer hardware, machine readable instructions (including firmware and/or software), or in any combination thereof.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A tunable apparatus for performing Surface Enhanced Raman Spectroscopy (SERS), said apparatus comprising:
a deformable substrate;
a plurality of SERS-active nanoparticles disposed at a plurality of locations on the deformable substrate, wherein the plurality of SERS-active nanoparticles are to enhance Raman scattered light emission from an analyte molecule located in close proximity to the SERS-active nanoparticles; and
wherein the deformable substrate is to be deformed to vary distances between the SERS-active nanoparticles, wherein varying distances between the SERS-active nanoparticles varies enhancement of an intensity of Raman scattered light emission from the analyte molecule.

2. The tunable apparatus according to claim 1, wherein the substrate comprises a fiber.

3. The tunable apparatus according to claim 2, wherein the fiber comprises a fiber formed of silk extruded by a spider.

4. The tunable apparatus according to claim 2, wherein the fiber comprises a hole running through at least a portion of the fiber.

5. The tunable apparatus according to claim 1, wherein the substrate comprises a plurality of individual fibers formed of a deformable material.

6. The tunable apparatus according to claim 1, wherein the substrate comprises an optical waveguide.

7. The tunable apparatus according to claim 1, wherein the substrate is stretchable along at least one dimension.

8. The tunable apparatus according to claim 1, wherein the substrate is bendable along at least one dimension.

9. The tunable apparatus according to claim 1, wherein the substrate comprises a roughened surface.

10. The tunable apparatus according to claim 1, wherein the plurality of nanoparticles comprises one or more materials selected from a list consisting essentially of: silver, gold, copper and platinum.

11. A surface enhanced Raman spectroscopy (SERS) system comprising:
a tunable apparatus for performing SERS, said tunable apparatus comprising:
a deformable substrate; and
a plurality of SERS-active nanoparticles disposed at a plurality of locations on the deformable substrate, wherein the plurality of SERS-active nanoparticles are to enhance Raman scattered light emission from a molecule located in close proximity to the SERS-active nanoparticles;
an illumination source to supply excitation light to cause Raman scattered light to be emitted from an analyte molecule;
an actuator to deform the substrate to vary distances between the SERS-active nanoparticles, wherein varying the distances between the SERS-active nanoparticles varies enhancement of an intensity of Raman scattered light emission from the analyte molecule; and
a detector positioned to detect the Raman scattered light emitted from the analyte molecule.

12. The SERS system according to claim 11, wherein the deformable substrate comprises a fiber formed of silk extruded by a spider.

13. The SERS system according to claim 11, wherein the deformable substrate comprises an optical waveguide and wherein the illumination source is to supply the excitation light into the deformable substrate.

14. The SERS system according to claim 13, wherein the deformable substrate is optically connected to at least one of the illumination source and the detector through an optical fiber.

15. The SERS system according to claim 11, wherein the tunable apparatus for performing SERS, the illumination source, the actuator, and the detector are integrated into a single chip.

16. A method for performing surface enhanced Raman spectroscopy (SERS) to detect an analyte molecule using a tunable apparatus having a deformable substrate, wherein a plurality of SERS-active nanoparticles and an analyte molecule are disposed on the deformable substrate, said method comprising:
causing Raman scattered light to be emitted from the analyte molecule, wherein the SERS-active nanoparticles enhance an intensity of the Raman scattered light emitted from the analyte molecule;
deforming the deformable substrate to vary distances between the SERS-active nanoparticles, wherein varying distances between the SERS-active nanoparticles varies enhancement of the intensity of the Raman scattered light emitted from the analyte molecule; and
detecting the Raman scattered light emitted from the analyte molecule.

17. The method according to claim 16, wherein the deformable substrate comprises an optical waveguide, said method further comprising:
illluminating the deformable substrate to cause an evanescent field to be generated near an exterior surface of the deformable substrate, wherein the evanescent field is to cause the Raman scattered light to be emitted from the analyte molecule.

18. The method according to claim 17, wherein illuminating the deformable substrate further comprises illuminating the deformable substrate through an optical fiber connecting an illuminating source to the deformable substrate.

19. The method according to claim 16, wherein the deformable substrate comprises an optical waveguide, wherein at least a portion of the Raman scattered light emitted from the analyte molecule is to illuminate the deformable substrate, and wherein detecting the Raman scattered light emitted from the analyte molecule further comprises detecting the Raman scattered light illuminating the deformable substrate.

20. The method according to claim 16, further comprising:
tuning the tunable apparatus by varying deformation of the substrate to multiple deformation states and detecting the Raman scattered light emitted from the molecule at the multiple deformation states.
